(19) United States
(12) Patent Application Publication
(10) Pub. No.: US 2004/0046274 A1
(43) Pub. Date: Mar. 11, 2004

(54) Method for producing a wear-resisting outsole

(76) Inventor: Chi-Kung Wu, Taichung Hsien (TW)

Correspondence Address: DELLETT AND WALTERS, 310 S.W. FOURTH AVENUE, SUITE 1101, PORTLAND, OR, 97204, US

(21) Appl. No.: 10/236,767

(22) Filed: Sep. 6, 2002

(51) Int. Cl. B29D 31/508

(52) U.S. Cl. 264/102; 264/244

(57) ABSTRACT

A method for preparing a wear-resisting outsole for a shoe, which mixes polyol polyurethane oligomer and prepolymer isocyanate together to form a mixed material. Then, the mixed material is poured into a shaping mold and coagulated by heating to form a TPU polymer outsole. Lastly, a substrate covers the mold and is bonded with the TPU outsole by a heat-pressure forming process to achieve a wear-resisting outsole.

### BACKGROUND OF THE INVENTION

1. Field of the Invention

The present invention relates to a method for producing a wear-resisting outsole, and more particularly to a method to form a thermoplastic urethane (TPU) outsole, which has an excellent wear-resisting feature.

2. Description of Related Art

A shoe has a bottom with an outsole to make contact with the ground and to enhance the friction between the shoe and the ground to keep a person wearing the shoe away from sliding and falling. The outsole is a particularly important element of sports shoes or sneakers that require an excellent ground-seizing capability on relatively smooth surfaces.

Most conventional outsoles in accordance with the prior art are made of rubber. However, rubber has a high wear-resisting coefficient, about 60-80 CBMM in DIN abrasion loss testing. The wear-resisting capability is inversely proportional to the wear-resisting coefficient. In other words, the wear-resisting capability is better when the wear-resisting coefficient is lower. Therefore, rubber outsoles are not durable and have to be thickened to make the outsoles have a longer life. When the outsole is made thicker, the shoe is too heavy and susceptible to uneven wear patterns. Both of these result in less than optimum performance by the user.

Additionally, when the rubber outsole is formed with a thermo-pressure forming process, a temperature of the process has to be in a range of 140° C.-180° C. so that very much energy is consumed in the process of forming the rubber outsole. Moreover, the rubber outsole easily decays if anything is wrong in the forming process resulting in the shoe outsole having bad quality.

To overcome the shortcomings, the present invention provides a method for making a wear-resisting outsole to mitigate and obviate the aforementioned problems.

### SUMMARY OF THE INVENTION

The main objective of the invention is to provide a method for producing a thermoplastic urethane wear-resisting outsole.

Objectives, advantages and novel features of the invention will become more apparent from the following detailed description when taken in conjunction with the accompanying drawings.

### BRIEF DESCRIPTION OF THE DRAWINGS

FIG. 1 is a block diagram of a method for preparing a wear-resisting outsole in accordance with the present invention; and

FIG. 2 is a perspective view of a TPU outsole made by the method in FIG. 1.

### DETAILED DESCRIPTION OF PREFERRED EMBODIMENT

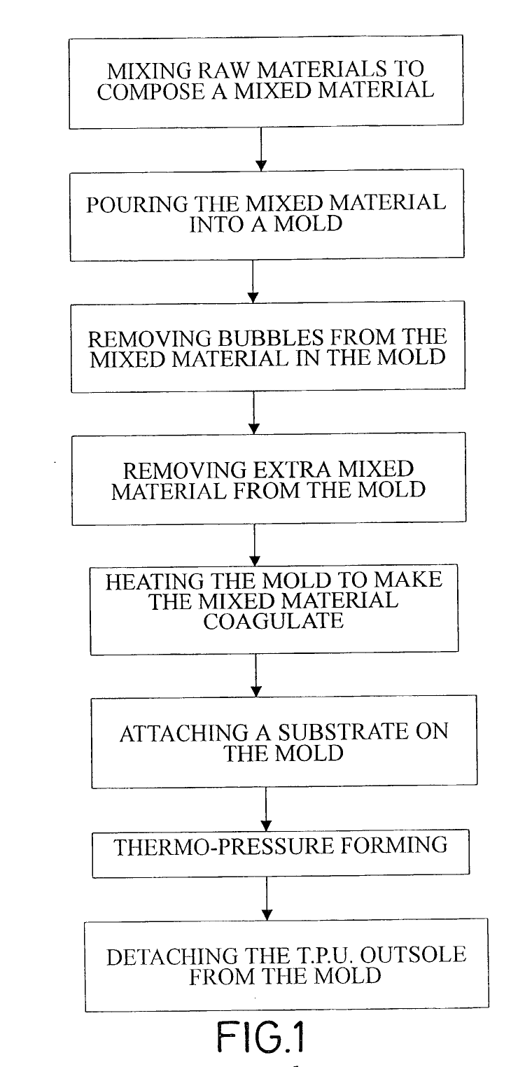

Sneakers and sport shoes have a bottom with a bottom to which a non-skid outsole is attached. With reference to FIG. 1, a method for preparing a wear-resisting outsole for a shoe consists of the following acts:

Mixing raw materials: Polyol hyper-branched polyurethane oligomer is mixed with pigments and prepolymer isocyanate to form the mixed material for the outsole.

Pouring the mixed material into a mold: A mold in a desired shape for an outsole is a one-piece plate mold having multiple concaves and is prepared and the mixed material is poured into the concaves of the mold.

Removing bubbles: The mold with the mixed material is placed in a vacuum chamber to draw bubbles in the mixed material out of the mixed material. Removing bubbles from the mixed material ensures that the outsole does not have vacant spaces inside to make the outsole break easily.

Removing excess mixed material from the mold: Excess mixed material around the mold is removed to make the outsole have a neat appearance.

Heating the mold to make the mixed material coagulate: the mold is heated at 50-60° C. for 8-12 minutes to make the polyol hyper-branched polyurethane oligomer and the prepolymer isocyanate polymerize and become a thermoplastic urethane elastomer (TPU) outsole.

Attaching a substrate on the mold: attaching a substrate to contact with the TPU outsole on the mold, wherein the substrate enables to combine with the TPU outsole and is preferred to be cloth. Thermo-pressure forming: The mold with the substrate is heated at a high temperature to make the substrate firmly combine with the outsole by merging the TPU with the substrate. Specifically, the TPU is melted and permeates the substrate to securely bond the substrate with the outsole after the TPU solidifies. The temperature is 45-65° C. and the pressure is 6 kg/cm² in the thermo-pressure forming process.

Detaching the outsole from the mold: After the substrate is bonded with the TPU outsole when the TPU solidifies, the substrate with the TPU outsole is detached from the mold when the mold is cold, whereby the wear-resisting outsole is achieved.

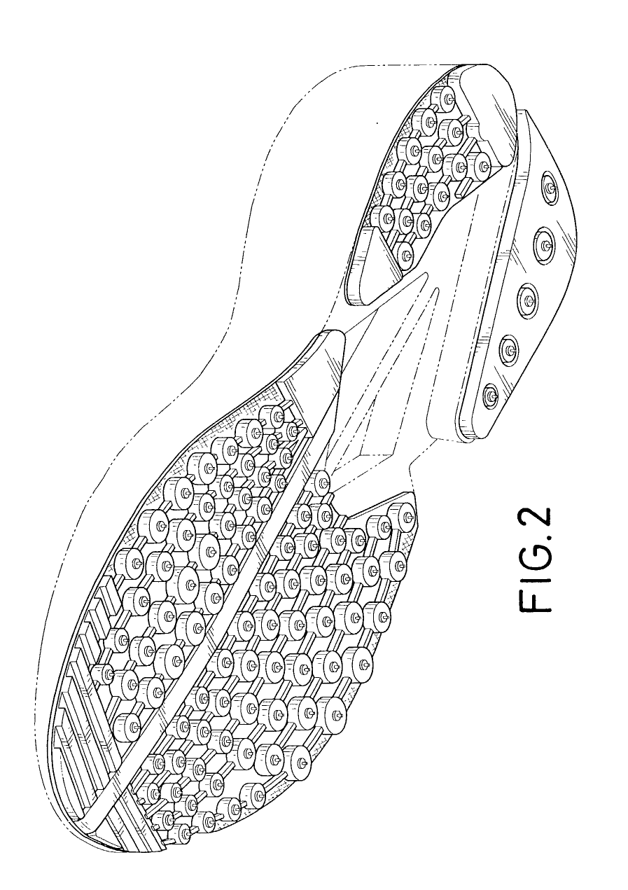

With reference to FIG. 2, an embodiment of the wear-resisting outsole is shown, wherein the wear-resisting outsole further has quick-strike efficiency by means of spikes configuration formed on bottom face of the outsole. The advantages a wear-resisting outsole produced with the method and the method include the following.

1. The TPU outsole produced by the method is soft and easy to be shaped to correspond to the bottom of a shoe to make the shoe comfortable when a user wears the shoes having the wear-resisting outsole.

2. The TPU outsole is durable and not easily broken because bubbles in the mixed material forming the outsole have been removed.

3. The thermo-pressure forming procedure is carried out at 45-65° C., which is a lower temperature range than the range required to form rubber outsoles. Therefore, energy is saved when the manufacturer uses this method to produce outsoles.

4. The TPU outsole ages slowly and keeps its shape for a long time.

5. The TPU outsole has a wear-resisting coefficient lower than 40 CBMM and is an excellent material to make the outsole durable. Additionally, the TPU outsole does not need to be thick to ensure a long life for the shoe.

It is to be understood, however, that even though numerous advantages of the present invention have been set forth in the foregoing description and function of the invention, the disclosure is illustrative only. Changes may be made in detail within the principles of the invention to the full extent indicated by the broad general meaning of the terms in which the appended claims are expressed.

What is claimed is:

1. A method for preparing a wear-resisting outsole comprising the following acts:
mixing raw materials: mixing polyol hyper-branched polyurethane oligomer with pigments and prepolymer isocyanate together to form a mixed material for the outsole;
pouring the mixed material into a mold: preparing a mold of desired shape for an outsole and pouring the mixed material into the mold;
removing bubbles: bubbles in the mixed solution are removed from the mixed material by placing the mold with the mixed material in a vacuum environment;
removing excess mixed material from the mold: removing excess mixed material around the mold to make the outsole have a neat appearance;
heating the mold to make the mixed material coagulate: the mold is heated to make the polyol hyper-branched polyurethane oligomer and the prepolymer isocyanate polymerize and become a thermoplastic urethane elastomer (TPU) outsole;
attaching a substrate on the mold: attaching a substrate to contact the TPU outsole on the mold to merge with the TPU outsole;
thermo-pressure forming: heating the mold with the substrate at high temperature to make the substrate firmly bond with the TPU outsole; and
detaching the outsole from the mold: cooling the mold and detaching the substrate with the TPU outsole from the mold.

2. The method for preparing wear-resisting outsole as claimed in claim 1, wherein the act of heating the mold to make the mixed material coagulate has following operational conditions:
temperature range: 50-60° C.; and
heating time: 8-12 min.

3. The method for preparing wear-resisting outsole as claimed in claim 1, wherein the act of thermo-pressure forming has following operational conditions:
temperature range: 45-65° C.; and
pressure: 6 kg/cm².

4. The method for preparing wear-resisting outsole as claimed in claim 1, wherein the substrate is cloth.
